(19) United States
(12) Patent Application Publication
(10) Pub. No.: US 2009/0127245 A1
(43) Pub. Date: May 21, 2009

(54) Cooking Appliance

(75) Inventors: Ingo Bally, Traunstein (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Guenter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 11/990,413

(22) PCT Filed: Jul. 26, 2006
(86) PCT No.: PCT/EP2006/064703

§ 371 Date: Feb. 13, 2008

(30) Foreign Application Priority Data
Aug. 17, 2005 (DE) 10 2005 038 883.3

(51) Int. Cl. H05B 1/00

(52) U.S. Cl. 219/447.1

(57) ABSTRACT

A cooking appliance, particularly an elevated-mounted cooking appliance, comprising: at least one muffle, which delimits a cooking compartment and whose muffle opening is surrounded by a muffle frame; a door for closing the muffle opening, and; a drive device, which is controlled by a control device and which serves to displace the door. A speed measuring device for determining the displacement speed of the door is provided that enables a pinching in the door to be detected by monitoring the displacement speed.

The present invention relates to a cooking appliance, particularly a cooking appliance mounted at an elevated level, comprising at least one muffle which defines a cooking compartment, with a muffle opening, a door which closes the muffle opening and a drive device controlled by a control device for driving the door.

A cooking appliance mounted at an elevated level is known from DE 102 28 140 A1, in which any trapping of objects in the area of the base door can be detected by means of a plurality of anti-trap protection switches, capable of actuation independently of one another, between the base door and the muffle frame. In this situation, it is also possible to evaluate a pressure increase in a door seal with a hollow profile.

An anti-trap protection facility is described in DE 101 64 239 A1, which is activated by different tensile forces acting on the load cables driving the base door. A torque sensor is also described which senses a load torque on the drive shaft of an electric motor. To this end, tensile force sensors, piezoelectric sensors and also deformation or tension/strain sensors are described as sensors.

DE 102 28 141 A1 additionally describes an optoelectronic sensor for the detection of a trapping situation, which switches by way of the quantity of reflected light.

Disadvantageous is the fact that the described anti-trap detection facilities are either relatively slow to respond (tensile force sensor) or are imprecise or susceptible to error (optosensor) and have additional installation resource requirements.

The object of the present invention is therefore to provide a fast, simple and precise anti-trap detection facility for a cooking appliance of the type described above.

The present object is achieved by the cooking appliance having the features described in claim 1 and also a method as claimed in claim 17.

To this end, the cooking appliance, which in particular is a cooking appliance mounted at an elevated level but can also be a cooking appliance with an oven carriage, is equipped with a speed measuring device in order to determine a travel speed of the door. As a result of the speed measuring device any trapping in the door area can be detected by monitoring the travel speed. In this situation, the travel movement does not have to be speed controlled but it can also for example be regulated in load dependent fashion by way of the motor voltage or the motor current. Advantageously, however, the travel movement of the door is also controlled and regulated in speed dependent fashion—in other words also in load dependent fashion—by way of a central control unit for example.

This speed-based anti-trap protection facility has the advantage that it responds comparatively quickly, can obtain precise input data and can be implemented relatively simply without major design measures.

The monitoring of the travel speed can be aimed at reducing the travel speed which is uncontrolled and is therefore not intentionally adjusted. This can happen in such a way that a value measured by the speed measuring device deviates by a fixed or percentage value from a nominal value. If the deviation exceeds or falls below a particular threshold value, then a trapping situation is assumed. For example, if a door can no longer travel at the selected nominal speed because an object prevents it from doing so, then its speed drops correspondingly. This evaluation and monitoring can for example be performed in a central control device, by way of suitable microcontrollers for example.

Alternatively or additionally, a—generally excessively fast—temporal change in the travel speed can trigger the trapping situation if for example the door is braked more quickly than intended in the trapping situation.

The values are naturally chosen such that speed fluctuations resulting from the regulation process for the door travel do not as a rule trigger any trapping situation. In addition, the anti-trap protection methods described in the prior art can also be used, such as a motor current measurement.

It is advantageous if the speed measuring device includes at least one sensor on a motor shaft of the drive device, in particular of a drive motor, by means of which corresponding sensor signals can be generated on rotation of the motor shaft. A comparatively fast response is possible as a result. The sensor signals are directly or indirectly a measure of the travel speed of the door. It is then particularly advantageous if the at least one sensor is a Hall sensor which outputs two sensor signals per revolution of the motor shaft. The Hall sensor system is simple to install, fast and non-sensitive. Advantageously, two Hall (part) elements are fitted on the motor shaft such that two signals are output during one revolution of the motor shaft. By evaluating the timing of these signals it is possible to ascertain a speed of the base door, for example by using comparison tables or a conversion in real time. By preference, the travel speed is detected by means of a time difference between the sensor signals.

In order to provide stable speed determination a plurality, in particular more than two, sensor signals are advantageously evaluated. To this end it is also advantageous if a plurality, in particular more than two, sensor signals are averaged.

In particular it is advantageous if the travel direction of the door reverses after detection of the trapping situation.

To this end an anti-trap protection device can be provided which handles the monitoring and/or an implementation of the measures to be performed in the trapping situation. The anti-trap protection device can be a separate device or can be functionally integrated into existing control circuits, for example into the central control circuit or into a control board or a lift board.

It is advantageous if the anti-trap protection or the anti-trap protection device is only capable of activation if a nominal travel value, in particular a nominal speed, for the door has been reached, which reduces the danger of erroneous triggering of the anti-trap protection.

In order to protect the object trapped in the door area, a maximum force-time curve is advantageously not exceeded by the door. Trapping ‘in the door area’ includes trapping between the door and an external boundary, the worktop for example, and also trapping between door and muffle frame or housing. Different force-time curves can be provided for both situations.

It is advantageous in particular for the closing situation if in addition at least one limit switch is present, which is located in the area between muffle opening or frame and door, whereby actuation of the at least one limit switch deactivates the anti-trap protection device or the anti-trap protection, in other words discontinues protection measures. This limit switch typically switches at an opening dimension of 4 mm, which is so small that objects can no longer be trapped. On the other hand, this ensures that the door does not unintentionally reverse while closing. On actuation of the at least one limit switch the door is pushed onto the muffle opening with a defined force—and is not longer speed controlled.

The speed measuring device can however also be used for other purposes, such as for selecting the travel speed of the door. This alone is not yet known and has also not been suggested.

The invention is particularly suited for cooking appliances mounted at an elevated level in which the muffle opening is a base-side muffle opening and the door is a base door which preferably moves in a linear fashion.

The invention will be described in detail in the following with reference to the attached schematic figures. In the figures:

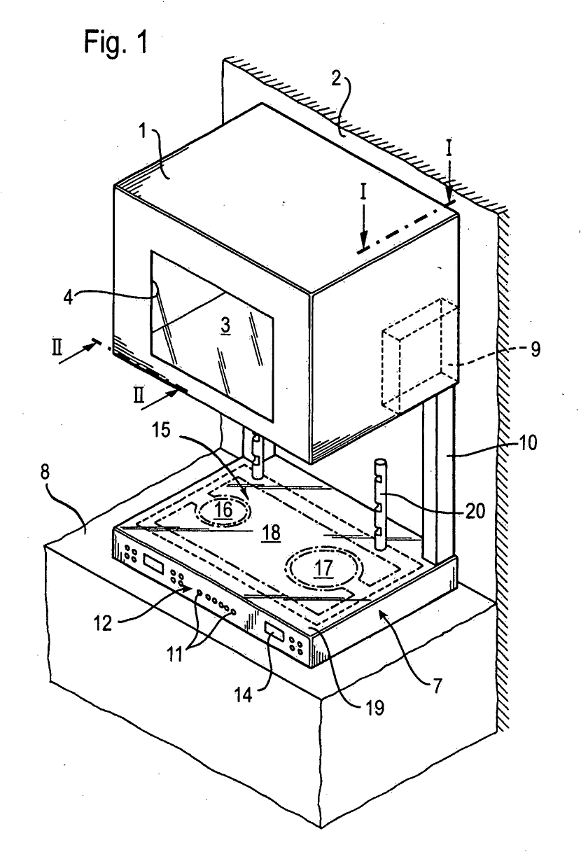

FIG. 1 shows a perspective view of a cooking appliance wall-mounted at an elevated level with the base door lowered;

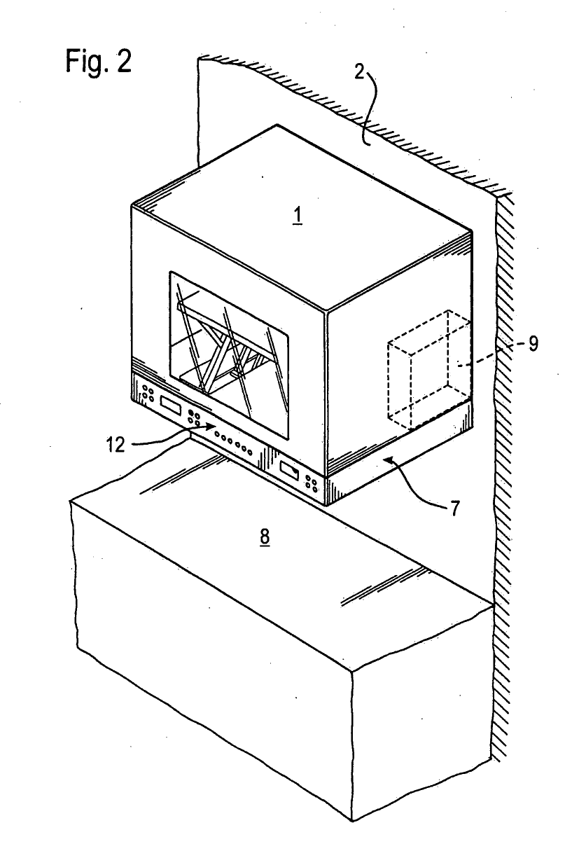

FIG. 2 shows a perspective view of the cooking appliance mounted at an elevated level with the base door closed;

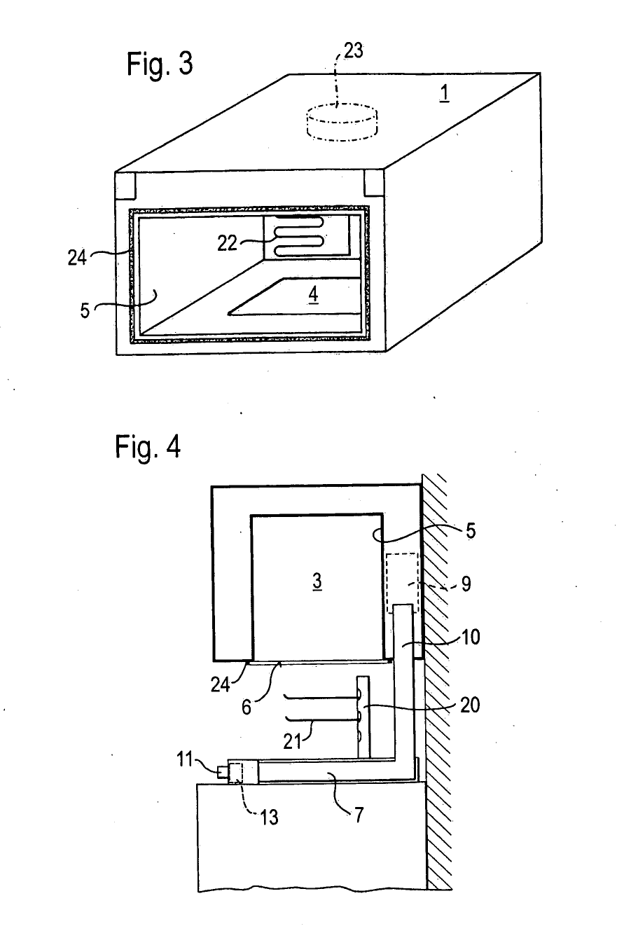

FIG. 3 shows a perspective view of a housing of the cooking appliance for mounting at an elevated level without the base door;

FIG. 4 shows a schematic side sectional view along the line I-I from FIG. 1 of the cooking appliance wall-mounted at an elevated level with the base door lowered;

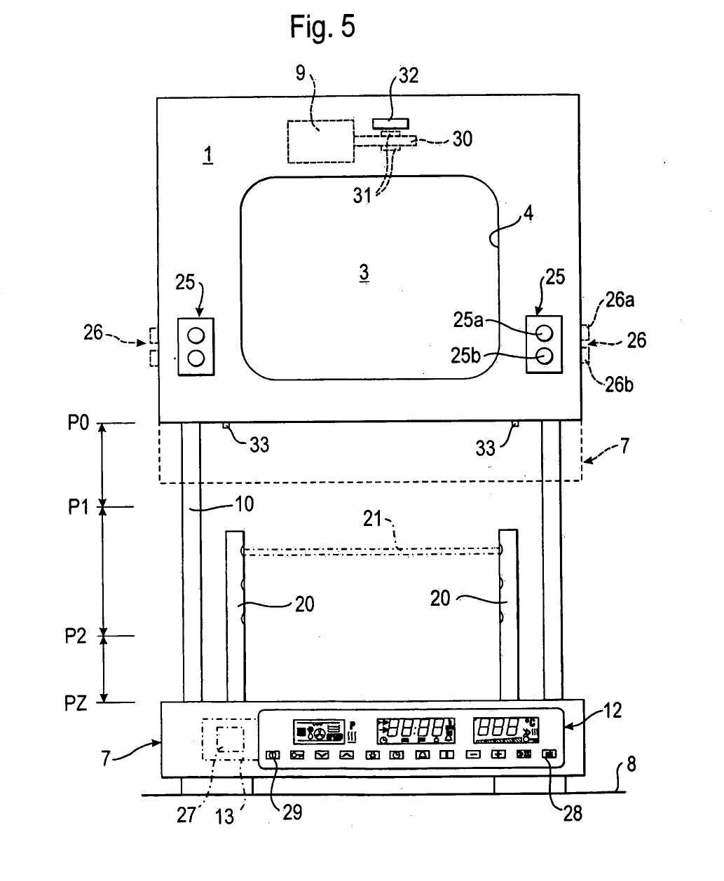

FIG. 5 shows a front view of a further embodiment of a cooking appliance mounted at an elevated level;

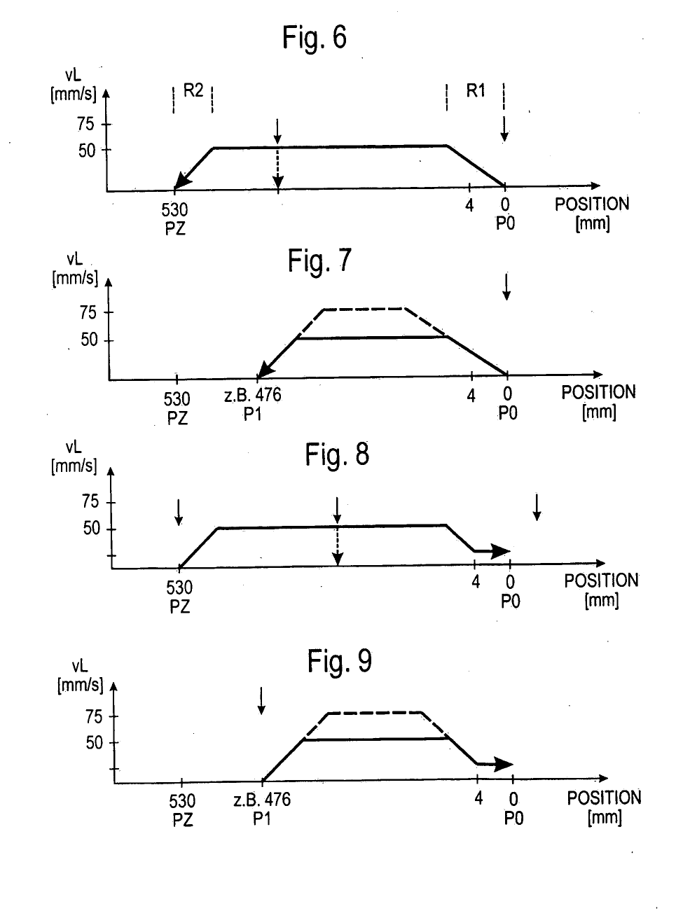

FIGS. 6 to 11 show diagrams of travel movements of a base door under different basic conditions;

FIGS. 12 and 13 show force-time profile curves for a base door.

FIG. 1 shows a cooking appliance mounted at an elevated level with a housing 1. The rear panel of the housing 1 is mounted on a wall 2 in the manner of a wall cabinet. Defined in the housing 1 is a cooking compartment 3 which can be monitored by way of a viewing window 4 incorporated in the housing 1. It can be seen from FIG. 4 that the cooking compartment 3 is delimited by a muffle 5 which is provided with a heat insulating casing which is not shown, and that the muffle 5 has a muffle opening 6 in its base. The muffle opening 6 can be closed with a base door 7. FIG. 1 shows the base door 7 in its lowered position, whereby its underside is in contact with a worktop 8 of a kitchen unit. In order to close the cooking compartment 3, the base door 7 must be moved to the position shown in FIG. 2, the so-called “null position”. In order to move the base door 7, the cooking appliance mounted at an elevated level has a drive device 9, 10. The drive device 9, 10 has a drive motor 9 represented in FIGS. 1, 2 and 4 by dashed lines, which is located between the muffle 5 and an exterior wall of the housing 1. The drive motor 9 is located in the area of the rear panel of the housing 1 and, as shown in FIG. 1 or 4, is in active engagement with a pair of lifting elements 10 which are connected to the base door 7. In this situation, according to the schematic side view shown in FIG. 4, each lifting element 10 is formed as an L-shaped carrier whose vertical component extends out of the drive motor 9 at the side of the appliance. In order to move the base door 7, the drive motor 9 can be actuated with the aid of a control panel 12 and a control circuit 13, which according to FIGS. 1 and 2 is located on the front of the base door 7. As shown in FIG. 4, the control circuit 13 is situated behind the control panel 12 inside the base door 7. The control circuit 13, which here is made up of a plurality of spatially and functionally separate printed circuit boards communicating by way of a communication bus, constitutes a central control unit for operation of the appliance and controls and/or regulates for example the heating, the travel of the base door 3, the implementation of user inputs, the illumination, the anti-trap facility, the pulsing of the heating elements 16, 17, 18, 22 and much more.

It can be seen from FIG. 1 that the upper side of the base door 7 has a cook zone 15. Almost the entire surface of the cook zone 15 is taken up by heating elements 16, 17, 18 which are indicated in FIG. 1 by dot and dash lines. In FIG. 1, the heating elements 16, 17 are two hotplate heating elements of different sizes which are spaced apart from one another, while the heating element 18 is a surface heating element provided between the two hotplate heating elements 16, 17, which almost surrounds the hotplate heating elements 16, 17. The hotplate heating elements 16, 17 define associated cooking zones or cook tops for the user; the hotplate heating elements 16, 17 together with the surface heating element 18 define a bottom heating zone. The zones can be indicated by means of a suitable decor on the surface. The heating elements 16, 17, 18 can be controlled by way of the control circuit 13 in each case.

In the embodiment illustrated the heating elements 16, 17, 18 are configured as radiant heating elements which are covered by a glass ceramic plate 19. The glass ceramic plate 19 has approximately the dimensions of the upper side of the base door 7. The glass ceramic plate 19 is moreover equipped with assembly openings (not shown) through which project pedestals for mounting holders 20 for food shelves 21, as also shown in FIG. 4. Instead of a glass ceramic plate 19, it is also possible to use other covers—preferably having a fast response—a thin plate for example.

With the aid of a control toggle provided on the control panel 12 the cooking appliance mounted at an elevated level can be switched to a hotplate or a bottom heat operating mode, which are described in the following.

In the hotplate operating mode, the hotplate heating elements 16, 17 can be individually controlled by way of the control circuit 13 by means of control elements 11 which are provided on the control panel 12, while the surface heating element 18 remains out of operation. The hotplate operating mode can be used when the base door 7 is lowered, as is shown in FIG. 1. It can however also be used with the cooking compartment 3 closed by the raised base door 7 in an energy saving function.

In the bottom heat operating mode, not only the hotplate heating elements 16, 17 but also the surface heating element 18 are controlled by the control device 13.

In order to achieve the most even possible browning of the food during cooking with bottom heat operation, it is crucial that the cook zone 15 providing the bottom heat exhibits an even distribution of the heating power output over the area of the cook zone 15 even though the heating elements 16, 17, 18 have different rated power outputs. By preference, the heating elements 16, 17, 18 are therefore not switched to continuous operation by the control circuit 13 but the power supply to the heating elements 16, 17, 18 is pulsed. In this situation, the differently rated heating power outputs of the heating elements 16, 17, 18 are reduced individually in such a manner that the heating elements 16, 17, 18 provide an even distribution of the heating power output over the area of the cook zone 15.

FIG. 4 schematically illustrates the location of a fan 23, used for example to generate an air circulation in the case of hot air operation or to provide a fresh air feed. Furthermore, a top-heating heating element 22 is provided mounted on an upper side of the muffle 5, which can be implemented in a single-circuit or multi-circuit form, for example with an inner and an outer circuit. Further heating elements—not shown here so as improve clarity—such as a ring heating element can also be present between the rear wall of the housing 1 and the muffle. Through the control circuit 13, the different modes of operation including also top heat, hot air or rapid heating for example can be selected by appropriately turning on and setting the heating power of the heating elements 16, 17, 18, 22, and if necessary activating the fan 23. The setting of the heating power can take place by means of suitable pulsing. In addition, the cook zone 15 can also be implemented differently, for example with or without an extended cooking zone, as a pure—single- or multi-circuit—warming zone without cook tops and so forth. The housing 1 has a seal 24 with the base door 7.

The control panel 12 is principally located on the front side of the base door 7. Alternatively, other arrangements are also conceivable, for example on the front side of the housing 1, divided up over different subfields and/or partially on side surfaces of the cooking appliance. Further configurations are possible. The control elements 11 are not restricted in respect of their type of construction and can for example include control toggles, toggle switches, pushbuttons and membrane keys, the display elements 14 include for example LED, LCD and/or touchscreen displays.

FIG. 5 shows a schematic front view, not to scale, of a cooking appliance mounted at an elevated level in which the base door 7 is open in contact with the worktop 8. The closed state is drawn in dashed lines.

In this embodiment, two travel switch panels 25 are situated on the front side of the permanently mounted housing 1. Each travel switch panel 25 comprises two pushbuttons, namely an upper CLOSE pushbutton 25a for a base door 7 traveling upward in the closing direction and a lower OPEN pushbutton 25b for a base door 7 traveling downward in the opening direction. In the absence of automatic operation (see below), the base door 7 travels upward only as a result of continuous depression of the CLOSE pushbuttons 25a on both travel switch panels 25, if possible; the base door 7 also travels downward only as a result of continuous depression of the OPEN pushbuttons 25b on both travel switch panels 25, if possible (manual operation). Since increased attentiveness on the part of the user is implicit in manual operation and, in addition, both hands are used here, an anti-trap facility is then only optional. With regard to an alternative embodiment, travel switch panels 26 are placed at opposite outer sides of the housing 1 with corresponding CLOSE pushbuttons 26a and OPEN pushbuttons 26b, as drawn in dashed lines.

The control circuit 13 drawn in dot and dash lines, which is situated in the interior of the base door 7 behind the control panel 12, switches the drive motor 9 in such a manner that the base door 7 travels gently, in other words not abruptly by simply turning on the drive motor 9 but by means of a defined ramp.

In this embodiment the control circuit 13 includes a memory unit 27 for storing at least one destination or travel position P0, P1, P2, PZ of the base door 7, preferably using volatile memory modules, for example DRAMs. If a destination position P0, P1, P2, PZ has been stored, after actuation of one of the pushbuttons 25a, 25b or 26a, 26b on the travel switch panels 25 or 26 respectively the base door can travel independently in the selected direction until the next destination position has been reached or one of the pushbuttons 25a, 25b or 26a, 26b is actuated again (automatic operation). In this embodiment the lowest destination position PZ corresponds to the maximum opening, the (null) position P0 corresponds to the closed state, and P1 and P2 are freely selectable intermediate positions. If the last destination position for a direction has been reached, it is moreover necessary to continue the travel in manual mode, if this is possible (in other words the most last end positions do not correspond to a maximum open state or to the closed end state). Similarly, if no destination position has been stored for one direction—which for example would be the case for an upward movement into the closed situation if only PZ is stored and not P0, P1, P2—it is then necessary for the travel in this direction to take place in manual mode. If no destination position is stored, for example in the case of a new installation or after a power disconnection, no automatic operation is possible. If the base door 7 travel takes place in automatic mode, then an anti-trap facility is preferably activated.

Automatic mode and manual mode are not mutually exclusive: as a result of continuous actuation of the travel switch panel(s) 25, 26 the base door 7 then also travels in manual mode if it were possible to travel in this direction to a destination position. In this situation, it is possible for example to define a maximum actuation time for the travel switch panels 25 and 26, or the associated pushbuttons 25a, 25b and 26a, 26b respectively, relating to activation of automatic mode, 0.4 seconds for example.

A destination position P0, P1, P2, PZ can be any position of the base door 7 between and including the null position P0 and the maximum opening position PZ. The maximum stored opening position PZ need not however be the position in contact with the worktop 8. Storing of the destination position P0, P1, P2, PZ can be performed with the base door 7 in the desired destination position P0, P1, P2, PZ, by means of, for example, actuating a confirmation pushbutton 28 on the control panel 12 for several seconds (duration two seconds for example). Existing optical and/or acoustic signal generators which output corresponding signals after storage of a destination position are not included in the drawing in order to improve clarity. Travel to the desired destination position P0, P1, P2, PZ to be selected occurs for example as a result—in this embodiment—of two-handed operation of the travel switch panels 25 and 26 and manual travel to this position.

The memory unit 27 can store only one or, as illustrated in this embodiment, also a plurality of destination positions P0, P1, P2, PZ. In the case of a plurality of destination positions P0, P1, P2, PZ, these can be reached in sequence by actuating the corresponding travel pushbuttons 25a, 25b and 26a, 26b. By having a plurality of destination positions P0, P1, P2, PZ, the cooking appliance mounted at an elevated level can be conveniently adapted to the desired operating height for a plurality of users. The destination position(s) can advantageously be deleted and/or overwritten. In one embodiment, for example, only one destination position can be stored in the open state, while the null position P0 is detected automatically and can be reached automatically. Alternatively, the null position P0 must also be stored in order for it to be automatically reachable.

It is particularly advantageous for ergonomic use if the or a destination position P1, P2, PZ opens the base door 7 at least approx. 400 mm to approx. 540 mm (in other words P1−P0, P2−P0, PZ−P0≧40 cm to 54 cm). Given this dimension of opening, the food shelves 21 can be simply inserted into the holders 20. In this situation, it is advantageous if the viewing window 4 is mounted approximately at or slightly below the eye level of the user, for example by using a template which indicates the dimensions of the cooking appliance.

Not included in the drawing is a power outage bridging facility provided for bridging a power outage of approx. 1 to 3 s, preferably up to 1.5 s.

The drive motor 9 from FIG. 1 has at least one sensor unit 31, 32 located on a motor shaft 30, before or after a gearbox where applicable, in order to measure a travel path or a position and/or a speed of the base door 7. The sensor unit can for example comprise one or more induction sensors, Hall sensors, opto-sensors, SAW sensors and so forth. In this situation, in order to perform simple distance and speed measurement two Hall (part) elements 31 are fitted here displaced by 180°—opposite one another in other words—on the motor shaft 30, and a Hall measuring sensor 32 is fitted at a fixed distance in this area of the motor shaft. If a Hall element 31 then travels past the measuring sensor 32 when the motor shaft 30 is rotating, a measurement or sensor signal is produced which is digital to a good approximation. With (not necessarily) two Hall elements 31, two signals are thus output during a rotation of the motor shaft 30. By carrying out a timing assessment of these signals, their time difference for example, the speed vL of the base door 7 can be determined, for example by using comparison tables or a conversion into real time in the control circuit 13. By means of addition or subtraction of the measurement signals it is possible to determine a travel path or a position of the base door 7.

A speed regulation facility can implement the speed for example by way of a PWM-controlled power semiconductor.

For the purpose of null point determination, the travel path measurement is automatically newly adjusted through initialization in the null position P0 of the base door 7 each time it starts to travel, in order for example to prevent an incorrect sensor signal output or recording from being passed on.

The drive motor 9 can be operated by actuating both travel switch panels 25 and 26 even if the main switch 29 is turned off.

Instead of two separate switches per travel switch panel 25, 26, one individual switch per travel switch panel is also possible, for example a toggle switch with a neutral position which switches only under pressure. Other forms are also possible. There is also no restriction on the type and arrangement of the control elements 28, 29 on the control panel 12.

In this situation the arrangement and distribution of the control circuit 13 is flexible and not restricted, in other words it can also comprise a plurality of boards, for example a display board, a control board and a lift board which are spatially separated.

A 4 mm opening dimension can be detected by limit switches 33 which deactivate an anti-trap facility when actuated.

The cooking appliance mounted at an elevated level can also be implemented without a memory unit 27, whereby no automatic operation is then possible. This can be useful for increased operational safety, for example to protect against trapping.

FIG. 6 shows a diagram, not to scale, of the travel speed vL of the base door 7 in mm/s plotted against the position of the base door in mm from the null position P0 for the base door 7 traveling from the closed state at P0=0 mm to PZ=maximum opening here of 530 mm in manual travel mode (in other words without automatic travel mode), and also, indicated by the dotted arrow, a stop in the travel movement between P0 and PZ. The curve progresses in the direction of the arrow, in other words from right to left. The downward pointing arrows present above the curve indicate actuations of the control panel 12.

The downward travel movement of the base door 7 begins with two-handed actuation of the travel switch panels 25, 26 or of the OPEN switches 25b or 26b, as indicated by the upper lefthand vertical arrow. The control circuit 13 regulates the drive motor 9 such that the base door 7 travels gently, in other words with a defined ramp R1, to its nominal speed here of vL=50 mm/s. The ramp R1 is linear here. The drive motor 9 is thus not simply turned on.

The travel movement is also load independent as a result, in particular it is independent of the payload of the base door 7 or changed mechanical friction circumstances. One input variable for this can be the rotational speed of the drive motor 9, which can be measured for example by means of Hall sensors.

After attaining the nominal speed of vL=50 mm/s, the base door 7 travels downward at a constant speed until it approaches the maximum opening PZ which results from the designed predefined maximum travel of the base door 7 or from reaching the worktop 8. In this figure it is assumed that the designed maximum opening PZ is reached. In this case, the control circuit 13 detects this approach and gently brakes the base door 7 automatically, in other words with a defined ramp R2, to PZ. Both ramps R1 and R2 can exhibit other gradients or shapes. The approach to the worktop can be detected by means of limit switches 33 and/or by monitoring the travel path.

If one or both of the travel switches 25b, 26b is/are released, as indicated by the upper lefthand vertical arrow, the base door 7 stops abruptly without a ramp, as indicated by the dotted arrow. In this mode, although the approach travel is thus gentle, this comes to an abrupt halt however—except on reaching the end position.

The cooking compartment 3 is not opened, in other words the base door 7 does not travel out of the null position P0 if an opening safety device is active, if therefore for example a particular temperature in the cooking compartment, 425° C. or 600° F. for example, is exceeded or if a child safety device is activated.

FIG. 7 shows a diagram similar to FIG. 6, not to scale, for the travel of the base door 7 from the closed state to a stored position P1=476 mm in automatic travel mode.

In this case, as a result of briefly actuating one of the OPEN switches 25b or 26b, as indicated by the upper righthand vertical arrow, the base door 7 begins automatically to travel to the position P1. In this situation also the base door 7 travels gently (righthand ramp) and is braked automatically (lefthand ramp). In this embodiment, in automatic mode it is possible to choose between two fixed nominal speeds, namely 75 mm/s (dashed line) and 50 mm/s (solid line), whereby the slower speed is advantageous particularly for older users. The ex-works default, for example, is the slower speed level. It is also possible to provide more than two speed levels, or nominal speeds; a free choice of setting for the nominal speed(s) by the user is also conceivable. Advantageously, it is also possible to switch at least between two speed levels of 50 mm/s and 65 mm/s, for example during initialization of an appliance.

FIG. 8 shows a diagram, not to scale, of the travel of the base door 7 from the maximum opening position PZ to the null position P0, in other words into the closed state, in manual mode.

The upward travel movement of the base door 7 begins with two-handed actuation of the CLOSE switches 25a and 26a, as indicated by the upper lefthand vertical arrow. The control circuit 13 regulates the drive motor 9 such that the base door 7 travels gently from PZ to its nominal speed of vL=50 mm/s, and then travels constantly at this nominal speed (to the right).

The control circuit 13 detects an approach to the null position P0 and gently brakes the base door 7 in good time beforehand. However, instead of now decelerating directly to the null position P0 by means of the linear ramp, 4 mm before the null position P0, speed dependent control is switched over to control using a defined voltage, in other words by supplying the motor 9 with an appropriate voltage. As a result, a maximum force development can be set with regard to blocking the drive motor 9. This voltage differs according to the previous history of the travel (payload, friction circumstances etc.). The detection of the 4 mm opening dimension is carried out by means of path measurement or additionally or alternatively by way of the limit switches 33. In the area from P0 to P0+4 mm it is also possible to dispense with an anti-trap facility.

If, as in FIG. 6, one or both of the travel switches 25b, 26b is/are released, as indicated by the upper righthand vertical arrow, the base door 7 stops abruptly with a ramp, as indicated by the dotted arrow.

FIG. 9 shows a diagram, not to scale, of the travel of the base door 7 from a stored position P1=476 mm to the closed state P0 in automatic travel mode. In contrast to the manual travel mode shown in FIG. 8, only one of the CLOSE switches 25a, 26a now needs to be actuated briefly, as indicated by the upper vertical arrow. The travel of the base door 7 is then analogous to that of FIG. 7, but in the other direction. On approaching the null position P0, by analogy with the situation from FIG. 8 the braking ramp for the last 4 mm of opening changes over from a speed controlled state to a load or closing force controlled state.

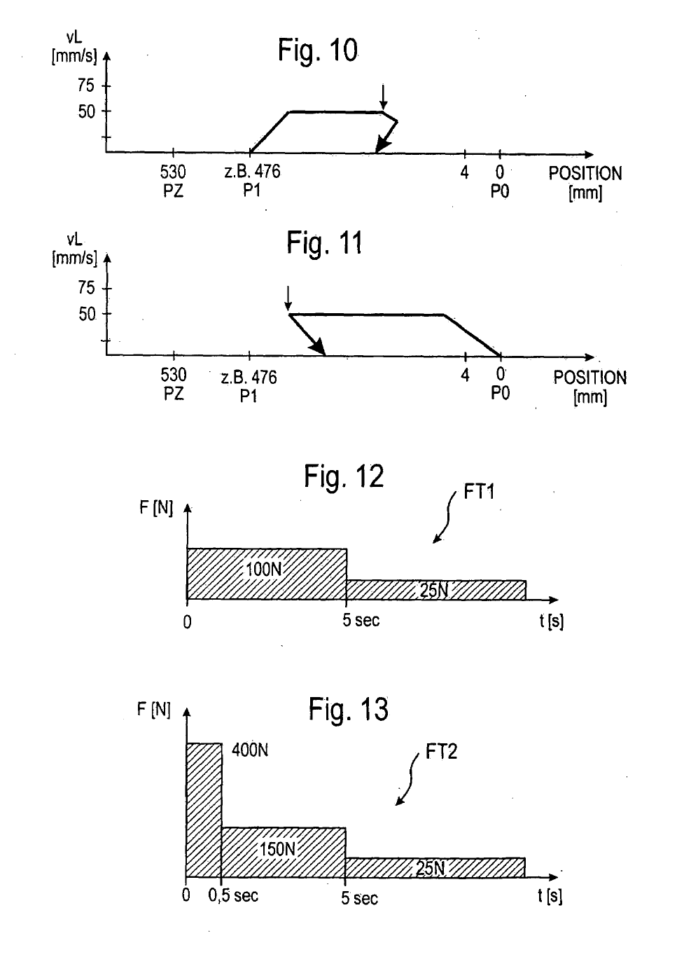

FIG. 10 shows a diagram analogous to FIG. 8, in which trapping now occurs at a nominal speed of vL=50 mm/s, as indicated by the upper vertical arrow. If a hand or cooking vessel etc., for example, becomes trapped between the base door 7 and the housing 1 the speed of the base door 7 drops because the object impedes further travel. Monitoring of the lift speed takes place here for example through evaluation of the sensor signals from the motor shaft, whereby for example the time between the measurement signals or pulses is evaluated. Only in the second instance is the motor current monitored, which is a slower method. In particular, the force which can be generated by the motor 9 for traveling is limited in order to avoid accidents resulting from excessively strong trapping (see also FIGS. 12 and 13). The deviation from the nominal speed is detected by the control circuit 13, for example through a speed deviation or a temporal change in the speed. Thereupon the base door reverses in order to allow the object to be removed; where appropriate a warning signal, for example an audible warning, is also output. Thereafter the base door 7 starts traveling only in the event of renewed appropriate actuation of a travel switch panel 25, 26.

In order to prevent the trapping situation from being incorrectly triggered, for example by a changed payload or a change in the running characteristics of the mechanism, firstly the anti-trap facility may only be activated if the base door 7 has attained its nominal speed (if a travel pushbutton 25a, 25b, 26a, 26b is previously released, the base door 7 immediately stops), and secondly a plurality of sensor signals may be evaluated, averaged for example.

FIG. 11 shows the trapping situation (upper vertical arrow) during the opening travel of the base door 7 in automatic mode to a destination position P1, in which an object becomes trapped between the underside of the base door 7 and the worktop 8. In this case, the trapping detection can take place by way of two redundant limit switches which detect a—in particular uneven—removal of load from the base door 7, whereupon the drive motor 9 reverses. The maximum permitted force-time profile (see FIGS. 12 and 13) is not exceeded in this situation.

FIG. 12 shows a maximum force F in N which can be applied to the base door 7 in a trapping situation occurring during travel in a closing direction (upwards in other words) plotted against the elapsed time t in s as a first force-time profile FT1.

In the trapping situation where t=0 s the possible closing force is limited to 100 N, corresponding to approx. 10 kg, for 5 s. This is useful for example if the motor 9 is boosted by the control device 13 in order to maintain the nominal speed. In particular this ensures that parts of the body are not injured. If the base door is operated for 5 s with (a maximum of) 100 N, the maximum force that can be applied is further reduced to 25 N, for example for 5 seconds. Thereafter this force level can be maintained or for example further reduced to 0 N. It should be stressed that this force-time profile FT1 specifies only the maximum force that can be applied, and the force actually applied lies beneath this as a rule, for example if the trapping situation is detected by the control device 13 and the base door 7 is correspondingly reversed after t=0.5, whereupon the applied force of 100 N drops to 0 N for example.

The maximum force threshold value of 100 N can also apply to further travel situations.

FIG. 13 shows a maximum force F in N which can be applied to the base door 7 in a trapping situation occurring during travel in an opening direction (downwards in other words) plotted against the elapsed time t in s as a second force-time profile FT2. Here the drive motor 9 can apply up to 400 N to the base door 7 in a first block of t=[0 s; 0.5 s], thereafter at t=[0.5 s; 5 s] 150 N and thereafter 25 N.

The time intervals and force threshold values for the force-time profiles FT1, FT2 can naturally be adapted to the structure and further basic conditions.

### LIST OF REFERENCE CHARACTERS

1 Housing
2 Wall
3 Cooking compartment
4 Viewing window
5 Muffle
6 Muffle opening
7 Base door
8 Worktop
9 Drive motor
10 Lifting element
11 Control element
12 Control panel
13 Control circuit
14 Display elements
15 Hob
16 Hotplate heating element
17 Hotplate heating element
18 Surface heating element
19 Glass ceramic plate
20 Holder
21 Food shelf
22 Top-heating heating element
23 Fan
24 Seal
25 Travel switch panel
25a CLOSE switch
25b OPEN switch
26 Travel switch panel
26a CLOSE switch
26b OPEN switch
27 Memory unit
28 Confirmation pushbutton
29 Main switch
30 Motor shaft
31 Hall element
32 Measuring sensor
33 Limit switch
FT1 First force-time profile
FT2 Second force-time profile
P0 Null position
P1 Intermediate position
P2 Intermediate position
PZ End position
R1 Speed ramp
R2 Speed ramp
vL Travel speed of base door

1-18. (canceled)

19. A cooking appliance comprising:
at least one muffle which defines a cooking compartment, the muffle having a muffle opening;
a door for moving into and out of a covering relationship with the muffle opening;
a control device for controlling appliance operation including door movement;
a drive device operatively associated with the door for driving movement thereof, the driving movement being controlled by the control device; and
a speed measuring device operatively associated with the door for determining a travel speed of the door.

20. The cooking appliance as set forth in claim 19 wherein the speed measuring device monitors the travel speed of the door so that trapping of an object in the door area may be detected.

21. The cooking appliance as set forth in claim 20 an uncontrolled reduction in the travel speed of the door indicates that an object is trapped in the door area.

22. The cooking appliance as set forth in claim 20 wherein a deviation of the travel speed of the door from a nominal speed indicates that an object is trapped in the door area.

23. The cooking appliance as set forth in claim 20 wherein a temporal change in the travel speed of the door indicates that an object is trapped in the door area.

24. The cooking appliance as set forth in claim 19 wherein the drive device includes a motor shaft; the speed measuring device including at least one sensor on the motor shaft of the drive device, whereby corresponding sensor signals can be generated on rotation of the motor shaft.

25. The cooking appliance as set forth in claim 24 wherein the at least one sensor is a Hall sensor which outputs two sensor signals per revolution of the motor shaft.

26. The cooking appliance as set forth in claim 24 wherein the travel speed is detected by a time difference between the sensor signals.

27. The cooking appliance as set forth in claim 24 further including means for evaluating and averaging a plurality of the sensor signals.

28. The cooking appliance as set forth in claim 20 further including means for reversing the travel direction of the door when the trapping of an object in the door area is detected.

29. The cooking appliance as set forth in claim 19 further including means for regulating the travel movement of the door; said means for regulating being dependent on the speed of the door.

30. The cooking appliance as set forth in claim 28 wherein the means for reversing the travel direction of the door is activated only if a nominal speed for the door has been reached.

31. The cooking appliance as set forth in claim 20 further including a means for limiting the maximum force-time profile of the door upon the detection of a trapped object in the door area.

32. The cooking appliance as set forth in claim 20 further including at least one limit switch located in the area between the muffle opening and the door, whereby actuation of the at least one limit switch deactivates the detectability of a trapped object in the door area.

33. The cooking appliance as set forth in claim 32, wherein the at least one limit switch can be actuated within an opening dimension of approximately 4 mm between the muffle opening and the base door.

34. The cooking appliance as set forth in claim 32 whereby upon actuation of the at least one limit switch the door is pushed onto the muffle opening with a defined force.

35. The cooking appliance as set forth in claim 19 wherein the cooking appliance is mounted at an elevated level, the muffle opening is a floor-side muffle opening and the door is a base door.

36. A method for operating a cooking appliance which includes at least one muffle door which defines a cooking compartment, a muffle opening, a door which closes the muffle opening, a control device, a drive device controlled by the control device for driving the door, comprising:
measuring the travel speed of the door; and
determining whether or not the travel speed of the door is dropping in an uncontrolled fashion whereby an object trapped in the door area may be detected.
